(19) United States
(12) Patent Application Publication
(10) Pub. No.: US 2025/0052095 A1
(43) Pub. Date: Feb. 13, 2025

(54) Tolerance Compensating Fastener and Wing Nut Therefor

(71) Applicant: Illinois Tool Works Inc., Glenview, IL (US)

(72) Inventors: Amit NAMANNAVAR, Maharashtra (IN); Nidhin KUNIYIL, Maharashtra (IN); Murali NAMANNA, Maharashtra (IN); Virupaxi PAYANNAVAR, Maharashtra (IN); Ravindra DESAI, Maharashtra (IN)

(21) Appl. No.: 18/795,669

(22) Filed: Aug. 6, 2024

(30) Foreign Application Priority Data
Aug. 7, 2023 (IN) 202311052979

(51) Int. Cl. E05B 79/06; B29C 45/14; B29L 1/00; F16B 37/16

(52) U.S. Cl. CPC E05B 79/06; F16B 37/16; B29C 45/14065; B29L 2001/005

(57) ABSTRACT

Examples relate to a wing-nut (114) for a tolerance compensating fastener (100) cooperable with a threaded fastening element (116). The wing-nut (114) having a rigid insert (306) and a body component (300). The rigid insert (306) formed as a hollow cylindrical body and comprising a plurality of retention elements (308) and a plurality of threads (302) formed on an inner wall of the hollow cylindrical body. The body component (300) surrounding the rigid insert (306), the body component (300) having an opening, coaxial with a central longitudinal axis of the rigid insert (306), to create a through-hole with the hollow cylindrical body to receive the threaded fastening element (116). Each of the plurality of retention elements (308) is encapsulated by the body component (300) to be interlocked and fixed in the body component (300).

### RELATED APPLICATIONS

The present application claims the benefit of Indian Patent Application number 202311052979, filed Aug. 7, 2023, titled “Tolerance Compensating Fastener and Wing Nut Therefor,” the contents of which are hereby incorporated by reference.

### BACKGROUND

Generally, a conventional tolerance compensating fastener is used for fastening two components that are to be coupled with each other, where tolerance compensating is a process of adjusting for minor variations in component dimensions or alignment during assembly of the two components. For instance, either or both of the two components can have minor variations in dimensions or tolerances because of which the two components may not automatically align during mounting or assembly. The conventional tolerance compensating fastener is used between the two components so that the conventional tolerance compensating fastener can accommodate the variations, tolerances and align with respect to one another. In general, the conventional tolerance compensating fastener can be formed of mainly two components that can move with respect to each other during assembly of the two components, such that the relative movement between the two components with respect to each other can compensate for the tolerances and align the two components that need to be fastened with one another. After alignment, a screw or other fastening component is inserted through the tolerance compensating fastener to securely join the two components.

### SUMMARY

The present disclosure relates generally to a tolerance compensating fastener, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1A illustrates a front view of a tolerance compensating fastener fastening a door handle assembly and a door panel of a vehicle, according to an example of the present subject matter.

FIG. 1B illustrates a rear view of the tolerance compensating fastener fastening the door handle assembly and the door panel of the vehicle, according to the example of the present subject matter.

FIG. 2A illustrates a front view of the tolerance compensating fastener, according to the example of the present subject matter.

FIG. 2B illustrates an isometric view of the tolerance compensating fastener, according to the example of the present subject matter.

FIG. 2C illustrates an exploded view of the tolerance compensating fastener, according to the example of the present subject matter.

FIG. 3A illustrates a sectional view of a wing-nut in a tolerance compensating fastener, according to one example of the present subject matter.

FIG. 3B illustrates a sectional view of the tolerance compensating fastener with a screw, according to an example of one present subject matter.

FIG. 3C illustrates an isometric view of the tolerance compensating fastener, according to one example of the present subject matter.

FIG. 3D illustrates a sectional bottom view of the tolerance compensating fastener across sectional plane D-D shown in FIG. 3C, in accordance with one example of the present subject matter.

FIG. 3E illustrates a sectional bottom view of the tolerance compensating fastener across sectional plane D-D shown in FIG. 3C, in accordance with another example of the present subject matter.

FIG. 4 illustrates a sectional view of the wing-nut in a tolerance compensating fastener having a flared portion in a rigid insert, according to another one example of the present subject matter.

FIG. 5 illustrates an exploded view of the tolerance compensating fastener including the rigid insert, according to another example of the present subject matter.

FIG. 6 illustrates a perspective view of the wing-nut showing the rigid insert therein, according to the other example of the present subject matter.

FIG. 7 illustrates a perspective view of the rigid insert of the wing-nut, according to the example of the present subject matter shown in FIG. 6.

FIG. 8 illustrates a method of manufacturing the wing-nut, according to the examples of the present subject matter.

FIG. 9 illustrates a method for assembling the first component and the second component, according to the examples of the present subject matter.

### DETAILED DESCRIPTION

Conventionally, vehicles, for example four-wheelers, two-wheelers, and the like, include various components that are to be assembled. However, at least some of those components may be manufactured with dimensional tolerances. For instance, a door handle assembly may be assembled with an exterior door panel of a vehicle. In an instance, in order to assemble two components of the vehicle together, each of the two components is aligned by aligning the respective openings of each of the two components. The openings may be an aperture on the main body or surface of the components that are to be fastened or assembled. The opening is generally a passage that allows access or connection from one side of the component to the other in multiple directions. In an example, the opening may be of various shapes (example, circular, rectangular, or irregular) and is typically designed to serve a specific purpose such as allowing access, accommodating fasteners, or enabling the passage of other components or materials. The construction of the opening usually involves creating a void in the component during manufacturing either by molding, cutting, drilling, or other mechanical or fabrication processes, depending on the material and design requirements of the component.

In view of the above, the two components of the vehicle are assembled by aligning the respective openings of each of the two components and fastening them through the respective openings. However, the opening of each of the two components is formed via either a punching process, forming process, or welding, which in turn, causes minor variations in dimensions. i.e., dimensional tolerances. The dimensional tolerances result in the creation of a gap between the two components when fastened together. Assembling the various components of the vehicle with gaps in between leads to inconsistencies during assembly. In this regard, the tolerances are required to be compensated to fill the gap between the components for assembling the components.

In some scenarios, the gap between two components may be filled by using the conventional tolerance compensating fastener that is pre-assembled on one of the two components of the vehicle. Further, a fastening component, such as a screw, is passed through one of the openings of each of the two components via the conventional tolerance compensating fastener. The conventional tolerance compensating fastener has a plurality of threads to accommodate the fastening component. However, the conventional tolerance compensating fastener only compensates for varying tolerance along the direction of a single axis or may freely move to compensate for the tolerance with one degree of freedom, since the conventional tolerance compensating fastener may has limited movement and degree of freedom. For this reason, a plurality of conventional tolerance compensating fasteners are required to be assembled to compensate for tolerances in varying or multiple directions. As a result, the entire assembly incorporating the plurality of conventional tolerance compensating fasteners becomes bulky and costly.

Furthermore, the material composition of components of the conventional tolerance compensating fasteners, such as a nut that receives the fastening component presents a significant challenge. Fastening elements made solely from flexible materials, such as plastic or similar materials, offer flexibility to accommodate tolerance variations but however, lack the strength to withstand high torque during assembly. When substantial force is applied, such fastening elements are prone to breaking or deforming. Conversely, fastening elements constructed entirely from strong materials like metal provide the required durability to withstand high torque, but lack the flexibility needed to compensate the tolerances and variations in component dimensions.

This challenge between strength and flexibility in material selection creates a need for an improved solution that can effectively combine both properties to address the complex requirements of compensating for tolerances, while maintaining durability, cost-effectiveness, and case of assembly.

The present subject matter discloses examples and aspects to, inter alia, address the above-mentioned problems. The present subject matter, in one example, relates to a wing-nut cooperable with a threaded fastening element and a tolerance compensating fastener to align the two components by compensating a gap and misalignment between the two components that are to be fastened. The threaded fastening element may be, for example, a screw, bolt, or the like. The gap may be any misalignment or space between the two components that are meant to be fastened together. The gap may occur, for example, due to manufacturing tolerances, material variations, assembly issues, or design requirements, and can affect the fit, function, and stability of the assembled parts.

The tolerance compensating fastener of the present subject matter is designed to have higher strength and durability to endure more torque while also having the flexibility to adjust to wider tolerance variations in different directions. Also, the tolerance compensating fastener is designed to be cost-effective. The tolerance compensating fastener may be used for fastening at least two components together that may require compensating tolerances. For example, but not limited thereto, the two components may be a door handle assembly and a door panel of a door assembly of a vehicle. The examples of the present subject matter are not limited thereto and may be applicable when fastening any two components of a vehicle, where the components may be any two components of the door assembly of the vehicle that require tolerance compensation.

The wing-nut of the present subject matter is designed in a manner that it may be durable and has sufficient strength to withstand higher torque received from the threaded fastening element to fasten at least two components, while also maintaining flexibility to compensate for varying tolerances in different directions. Additionally, the wing-nut improves fastening efficiency and offers increased resistance to damage, potentially extending its operational life and broadening its applicability across various industries. In other words, the wing-nut of the present subject matter is designed in a manner that it is cooperable with the threaded fastening element, where the wing-nut may be a component of the tolerance compensating fastener that may aid in fastening, while the other components of the tolerance compensating fastener may compensate the varying tolerances. However, the implementations of the wing-nut of the present subject matter are not limited thereto and may be implemented in various fixtures for fastening.

The wing-nut of the present application may include a rigid insert and a body component. The body component may surround the rigid insert and may have an opening, coaxial with a central longitudinal axis of the rigid insert, to create a through-hole with a hollow cylindrical body of the rigid insert to receive the threaded fastening element. In an example, the rigid insert may be a metal insert. In another example, the body component may be of plastic material. The wing-nut includes the rigid insert that may be formed as having a hollow cylindrical body with internal threads, encapsulated within the body component, typically made of plastic. The rigid insert provides durability and thread strength, while the body component allows for complex geometries and weight reduction.

The rigid insert of the wing-nut may be formed as the hollow cylindrical body having a proximal end and a distal end, where the proximal end may be an end of the rigid insert facing towards an end of the wing-nut for receiving the threaded fastening element and the distal end may be an end that is axially opposite to the proximal end. The rigid insert may have a plurality of threads and a plurality of retention elements. The plurality of threads of the rigid insert may be formed on an inner wall of the hollow cylindrical body to receive and lock the threaded fastening element through the plurality of threads. The plurality of retention elements may be at the proximal end of the rigid insert, where each of the plurality of retention elements is encapsulated by the body component to be interlocked and fixed in the body component. The plurality of retention elements may be designed in a manner to retain the rigid insert in its original position and to stay integrated with the body component, even in case an opposing force is applied by the threaded fastening element while fastening. The plurality of retention elements at the proximal end of the rigid insert, that are encapsulated by the body component, ensure that the rigid insert remains securely interlocked and fixed even under high torque with the body component.

According to an example, a technique for manufacturing a wing-nut as illustrated above may include placing a rigid insert in a cavity of a mold. The rigid insert may be of similar configurations, as stated above, having the plurality of threads and the plurality of retention elements at the proximal end of the rigid insert. Further, positioning a filler in the hollow cylindrical body of the rigid insert accommodated in the mold. Further to positioning, injecting overmolding material around the rigid insert in the mold. The overmolding material may surround the rigid insert may be of similar configurations as stated above and may form an opening coaxial with the hollow cylindrical body of the rigid insert, to create a through-hole with the hollow cylindrical body of the rigid insert. Allowing the overmolding material to cool to form a body component around the rigid insert, where the plurality of retention elements is to interlock and fix to the body component. Lastly, extracting the wing-nut from the mold.

Through the above-mentioned examples, the rigid insert may be completely locked in the wing-nut along with the plastic fabrications while the overmolding process. Additionally, the rigid insert, through the above-mentioned plurality of retention elements, may ensure that the rigid insert is completely locked in with the plastic fabrications of the wing-nut and does not shear or cut off the wing-nut as and when more torque is applied on the screw while fastening. In this manner, the wing-nut may withstand more torque. Through these implementations, the wings of the wing-nut may provide a positive lock with plastic fabricated parts of the wing-nut while the process of overmolding the rigid insert part may cling and lock tenaciously with the wing-nut, i.e., plastic fabricated and mates with the rigid insert. Through the above-mentioned implementations, the rigid insert is efficiently locked in and does not shear and cut the wing-nut as and when the screw with higher torque is inserted.

The wing-nut of the present subject matter is designed to allow for higher torque applications than traditional all-plastic wing-nuts, while maintaining case of manipulation. This design potentially reduces material costs compared to all-metal alternatives, offering a balance between strength and economy.

Further, the manufacturing technique employs precision insert placement combined with versatile overmolding. This technique results in wing-nut that offer superior torque resistance and weight optimization. The overmolding allows for the creation of complex geometries, enhancing design flexibility beyond what is achievable with traditional single-material fasteners. The disclosed techniques ensure the rigid insert's strength is preserved while enabling the formation of intricate external shapes tailored to specific applications.

In another example, the wing-nut may be implemented in the tolerance compensating fastener of the present subject matter.

The tolerance compensating fastener may be designed to align the two components in such a manner that the tolerance compensating fastener allows movement up to six degrees of freedom. This way, the movement in all six directions allows two components, such as a first component and a second component, to be aligned such that the misalignment as well as the gap between the two components to be fastened may be compensated through the threaded fastening element. The tolerance compensating fastener of the present subject matter may have six degrees of freedom of movement, which allows the tolerance compensating fastener to move in any of the six directions, until the first component and the second component are aligned. By way of which, the tolerance compensating fastener of the present subject matter because of being designed to have six degrees of freedom may move to align the first component and the second component, by way of which, misalignment between the two components is rectified and correspondingly by aligning the gap is compensated as well. The tolerance compensating fastener may include a compensation nut, a floatation element, a mounting element, and a wing-nut.

The compensation nut may be a hollow cylindrical body and have an external wall having a thread-like profile. Further, the compensation nut may have a free end and an insertion end, where the insertion end may receive the threaded fastening element and the free end is distal to the insertion end. The floatation element may engage at the free end of the compensation nut. The floatation element may have a floatation-element aperture coaxially aligned with respect to the hollow cylindrical body of the compensation nut, the floatation element being movably mountable to one of the two components. The mounting element may have a mounting-element aperture coaxially aligned with the central longitudinal axis of the compensation nut and the floatation-element aperture of the floatation element. The mounting element may be interlocked with the floatation element and is movably mountable to one of the two components.

In view of the above configuration, the tolerance compensating fastener including the compensation nut, the floatation element, and the mounting element may be capable of being assembled together to be mounted as single-unit on one of the two components to form a first sub-assembly. The single-unit assembly of the tolerance compensating fastener including the compensation nut, the floatation element, and the mounting element, in order to assemble the two components, may be capable of exhibiting a movement having at most six degrees of freedom on receiving the threaded fastening element from the insertion end of the compensation nut. The tolerance compensating fastener may be movable in all 6 direction as per the requirement to align the two components that require to be fastened, by aligning the tolerance compensating fastener compensates the variation, misalignment and the gaps between the two components. The wing-nut may be mountable, away from the insertion end and to receive the threaded fastening element. The wing-nut may have similar configurations as illustrated above and have not been repeated here for the sake of brevity.

According to an example, in order to align two components through the tolerance compensating fastener as illustrated above, the technique may require aligning the two components, where the alignment may include positioning the corresponding apertures of each of the two components with respect to each other. In an example, the two components may be any components that are to be fastened together, such as components of the vehicle. In an example, one of the two components may have a first aperture and the other of the two components may have a second aperture. In order to align the two components to compensate for the misalignment and also fill the gap, the first aperture and the second aperture may have to be aligned co-axially with respect to each other. The tolerance compensating fastener may be fastened between the two components in a manner that the compensation nut, the floatation element, and the mounting element may as a single unit be mountable on one of the two components, thereby forming a first sub-assembly. This also includes aligning the first aperture of one of the two components with a through-hole of the tolerance compensating fastener, where the compensation nut, the floatation element, and the mounting element are capable of collectively exhibiting a movement having at most six degrees of freedom. The through-hole may be, for example, the continuous opening or passage that extends completely through the body of the tolerance compensating fastener from one end to the other and runs along the central longitudinal axis of the tolerance compensating fastener and allows for the insertion and reception of another fastening element or the passage of materials, such as the threaded fastening element. The other of the two components may be positioned with the first sub-assembly in a manner that the second aperture of the other of the two components is aligned with the first sub-assembly. Further, the wing-nut is locked with the components of the tolerance compensating fastener of the first sub-assembly. In an example, the wing-nut may be locked by a locking component. In one example, the locking component may be a snap-fit lock, a clip, a latch, rivet, clamp, and the like. This way, the other of the two components may be positioned between the wing-nut and the first sub-assembly, i.e., between the wing-nut and the single unit assembly of the compensation nut, the floatation element, and the mounting element. The wing-nut may have similar configurations as illustrated above and have not been repeated here for the sake of brevity.

When assembled, the compensation nut, floatation element, and mounting element as a single unit are assembled on one of the two components, and the wing-nut is assembled on the opposite side of the single unit with the other of the two components sandwiched therebetween. As soon as the threaded fastening element is passed through the insertion end of the compensation nut and correspondingly through the floatation element and then through the mounting element, the single unit mounted on one of the two components collectively exhibits a movement having at most six degrees of freedom. The tolerance compensating fastener is designed to correct misalignments between two components in up to six degrees of freedom, encompassing both positional and rotational adjustments. This means the tolerance compensating fastener can compensate for gaps (linear displacements) as well as angular misalignments between the components. The six degrees of freedom may include, for example, three translational movements (up/down, left/right, forward/backward) and three rotational movements (pitch, yaw and roll). As the threaded fastening element is inserted, the tolerance compensating fastener having the compensation nut, floatation element, and mounting element—can collectively move in any combination of these six degrees. This movement allows the tolerance compensating fastener to dynamically adjust its position and orientation, effectively filling gaps and correcting misalignments between the two components being fastened. In case the issue is a linear offset causing a gap, or an angular misalignment causing the components to be tilted relative to each other, the tolerance compensating fastener may have the ability to move in these six degrees of freedom enabling it to adapt and ensure proper alignment, contact, and gap between the components. This comprehensive adjustment capability ensures that the fastener can accommodate a wide range of manufacturing tolerances and assembly variations, resulting in a secure and properly aligned connection.

The wing-nut lastly receives the threaded fastening element and cooperates with the threaded fastening element as it passes through the compensation nut, the floatation element, and the mounting element, ultimately fastening and engaging to correct the misalignment and fill the gap between the two components. This configuration allows for alignment of the two components by positioning corresponding apertures with respect to each other. The tolerance compensating fastener can be mounted as a single unit on one component, with the other component positioned between the wing-nut and this assembly. This design enables the fastener to effectively compensate for misalignment and gaps arising from manufacturing tolerances, material variations, assembly issues, or design requirements, thereby ensuring proper fit, function, and stability of the assembled parts.

In view of the above arrangement, the tolerance compensating fastener may have the flexibility to compensate for the tolerance variations at different directions through plastic fabrications as well as provide strength to withstand more torque without breaking through the rigid insert. The tolerance compensating fastener of the present subject matter may be designed as such to be durable, effective, and less costly. The tolerance compensating fastener, through the rigid insert in the wing-nut, provides flexibility to an operator to fasten components at varying torque as the tolerance-adjusting component may be able to withstand the torque without breaking. Additionally, the plurality of threads provided on the wing-nut in the tolerance compensating fastener may be consistent and may not easily break off, as the rigid insert may also provide support to the plurality of threads. Additionally, the tolerance compensating fastener of the present subject matter is fabricated with the body component along with the rigid insert via overmolding, which is less time-consuming and less expensive. Additionally, provides the strength of the rigid insert along with the flexibility to the tolerance compensating fastener to compensate for varying tolerances in different directions.

The present subject matter offers significant technical advancements and solutions to address the problems associated with conventional fastening and tolerance compensating techniques. Unlike conventional tolerance compensating fasteners that only compensate for varying tolerance along the direction of a single axis or may freely move to compensate for the tolerance with only one degree of freedom, the present tolerance compensating fasteners design allows for movement with up to six degrees of freedom. In other words, the tolerance compensating fastener is capable of moving in six direction and correspondingly, this capability enables effective compensation for misalignments and gaps in multiple directions, eliminating the need for multiple fasteners and reducing assembly bulk and cost. The wing-nut's innovative design, incorporating a rigid insert within a body component, addresses the dichotomy between strength and flexibility in material selection. This combination provides the durability to withstand high torque during assembly while maintaining the necessary flexibility to accommodate manufacturing tolerances and variations in component dimensions. The fastener's design, featuring coaxially aligned apertures and an interlocking mechanism between elements, ensures smooth installation and stable positioning. The ability to mount the compensation nut, floatation element, and mounting element as a single unit on one component, with the other component positioned between the wing-nut and this assembly, offers flexibility in installation and adjustment. By combining the strength of a rigid insert with the flexibility of a body component through an overmolding process, the fastener achieves a balance between durability and economy. The fastener's ability to effectively manage misalignments and fill gaps ensures proper fit, function, and stability of assembled parts, potentially enhancing the overall structural performance of the assembled components. These advancements collectively address the limitations of conventional tolerance compensating fasteners, offering a more efficient, cost-effective, and versatile solution for managing component assembly challenges in various industries, including automotive manufacturing.

The present subject matter is further described with reference to the accompanying figures. Wherever possible, the same reference numerals are used in the figures and the following description to refer to the same or similar parts. It should be noted that the description and figures merely illustrate principles of the present subject matter. It is thus understood that various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

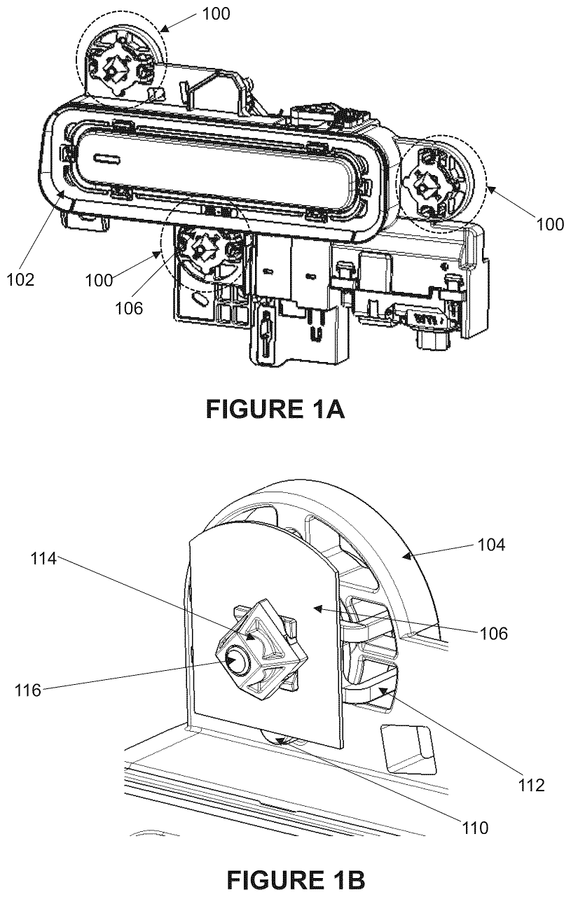

FIG. 1A illustrates a front view of a tolerance compensating fastener 100 fastening a door handle assembly 102 and a door panel of a vehicle, according to an example of the present subject matter. FIG. 1B illustrates a rear view of the tolerance compensating fastener 100 fastening the door handle assembly and the door panel of the vehicle, according to an example of the present subject matter. For the sake of brevity, FIGS. 1A-1B have been explained in conjunction with each other.

Examples of the present subject matter relate to the tolerance compensating fastener 100 which is fabricated with a body component and a rigid insert through overmolding. The tolerance compensating fastener 100 is designed to have higher strength, be durable, effective, and less costly while having the durability to endure more torque while also having the flexibility to adjust to wider tolerance variations. The tolerance compensating fastener 100 may be used for fastening at least two components. In one example, the at least two components may include a frame 106 of a door handle assembly 102 and a reinforcement panel 104 of a door panel of a vehicle. The frame 106 of the door handle assembly 102 may be fastened to the reinforcement panel 104.

The implementations of the tolerance compensating fastener 100 of the present subject matter have been hereinafter illustrated for fastening a door assembly of a vehicle, where the components that need to be fastened are for example a door handle assembly 102 and a door panel, in this regard, the two components may be the frame 106 of the door handle assembly 102 and the reinforcement panel 104 of the door panel of a door assembly of vehicle. However, the implementations of the present subject matter are not limited thereto and may be implemented for fastening different components of the vehicle to compensate for varying tolerances. In an example, the two components may be any two panels, any two frames, and the like of the vehicle, an electrical device, an electronic device, a machine, a furniture, an industrial equipment, and the like. For the sake of brevity in the present example, the components two be fastened may be referred to as the door panel and the door handle assembly of the vehicle are the components that need to be fastened.

As illustrated in FIGS. 1A and 1B, in order to connect the door handle assembly 102 with the door panel, the frame 106 of the door handle assembly 102 may have to be fastened with to the reinforcement panel 104 of the door panel. The tolerance compensating fastener 100 may be pre-assembled and mounted to the reinforcement panel 104 of the door panel to form a first sub-assembly. Further, frame 106 of the door handle assembly 102 may be positioned in a way to align with the first sub-assembly and a wing-nut may be locked therewith in a manner that the frame 106 may be accommodated between the tolerance compensating fastener 100. The tolerance compensating fastener 100 of may include a compensation nut (not shown), a floatation element 110, a mounting element 112 and the wing-nut 114, which work together to align the two component to compensate for misalignment and gaps between two components (in this example being the reinforcement panel 104 and the frame 106) being fastened.

The tolerance compensating fastener 100 may align the reinforcement panel 104 and the door panel of the vehicle. The reinforcement panel 104 and the frame 106 each separately has an aperture (not shown), such that the aperture on each panel (frame 106 and the reinforcement panel 104) corresponds to a size to efficiently accommodate a threaded fastening element 116. Each of the apertures, i.e., a first aperture of the reinforcement panel 104 and a second aperture of the frame 106 may be aligned, such that the tolerance compensating fastener 100 may be accommodated therebetween to compensate the misalignment and the varying gap.

As stated above, the compensation nut (not shown), the floatation element 110, the mounting element 112, and the wing-nut 114, work together to compensate for gaps between two components (in this example being the reinforcement panel 104 and the frame 106) being fastened. The compensation nut may have a hollow cylindrical body with an external thread-like profile, and has a free end and an insertion end, where the insertion end 202-1 for receiving the threaded fastening element 116. The threaded fastening element 116 may be a screw, a bolt, and the like. The threaded fastening element 116 may fasten the two components.

The floatation element 110 may engage at the insertion end of the compensation nut 200 and may have a floatation-element aperture (not shown) aligned with the compensation nut's central longitudinal axis. Further, the mounting element 112 may interlock with the floatation element 110 and may correspondingly have a mounting-element aperture aligned with the floatation-element aperture and the central longitudinal axis of the hollow cylindrical body of the compensation nut, also being movably mountable to the reinforcement panel 104 of the door panel. The frame 106 may be positioned between the wing-nut 114 and the tolerance compensating fastener (including the other components which may the single unit assembly of the compensation nut, the floatation element 110 and the mounting element) that may be pre-assembled and mounted on the one the reinforcement panel 104, as illustrated in FIG. 1A-1B. The threaded fastening element 116 may be inserted through the reinforcement panel 104 towards the second aperture of the frame 106 accommodating the door handle assembly 102, to fasten the frame 106 with the reinforcement panel 104.

Together, the compensation nut, floatation element 110, and mounting element 112 can collectively move with up to six degrees of freedom, as will be explained in detail. The tolerance compensating fastener 100 may, as and when the threaded fastening element 116 is inserted into the tolerance compensating fastener 100, compensate the varying tolerances and different directions, as will be explained later.

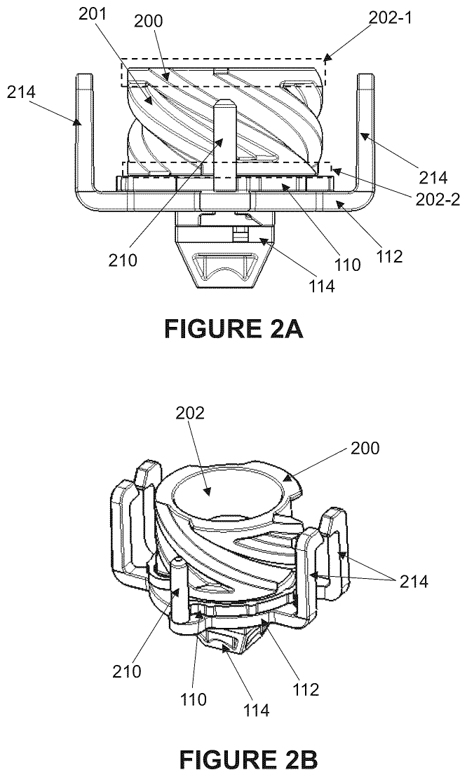

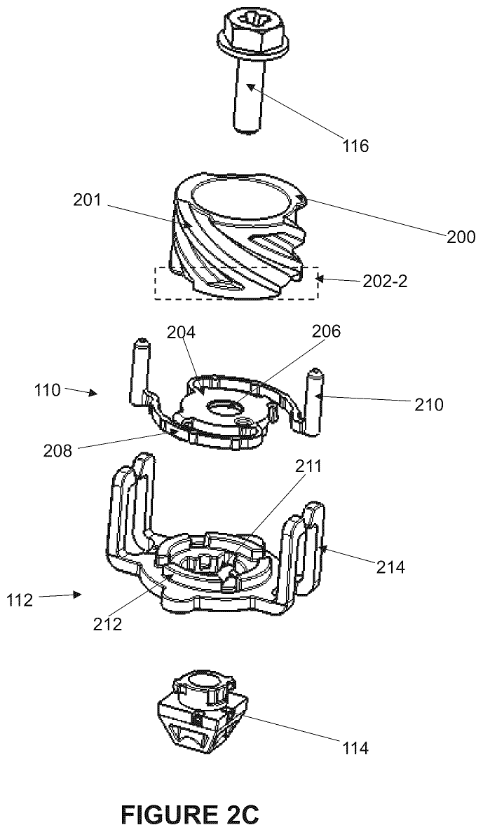

FIG. 2A illustrates a front view of the tolerance compensating fastener 100, according to an example of the present subject matter. FIG. 2B illustrates an isometric view of the tolerance compensating fastener 100, according to an example of the present subject matter. FIG. 2C illustrates an exploded view of the tolerance compensating fastener 100, according to an example of the present subject matter. For the sake of brevity, FIGS. 2A-2C have been explained in conjunction with each other.

As stated in respect of FIGS. 1A to 1B, the tolerance compensating fastener 100 may include the compensation nut 200, the floatation element 110, mounting element 112.

In an example, the compensation nut 200 of the tolerance compensating fastener 100 may be the hollow cylindrical body 202 with an external wall having a thread-like profile 201. In an example, the thread-like profile 201 may be in shape of a helical ridge or groove on the external wall of the compensation nut 200. In one example, the compensation nut 200 may be in the shape of a ring with the thread-like profile 201 in the shape of a plurality of helical threads on its outer surface, such that the thread-like profile 201 may correspond to corresponding profile (not shown) on the reinforcement panel 104 of the door panel to be fastened. The door panel may have a profile resembling the thread-like profile 201 of the compensation nut 200 to enable varying positioning and secure fastening to compensate the gap while fastening. The thread-like profile 201 allows the compensation nut 200 to adjust its position along its longitudinal axis, compensating for gaps between components to be fastened.

The compensation nut 200 may have the insertion end 202-1 and the free end 202-2, with the insertion end 202-1 to receive the threaded fastening element 116, such as a screw or bolt. For example, in automotive applications, this could help align the door handle assembly 102 with the door panel despite minor manufacturing variations.

The floatation element 110 engages at the free end 202-2 of the compensation nut 200. The floatation element 110 comprises a base portion 204, the floatation-element aperture 206, a plurality of flexible arms 208 and a plurality of fixing components 210. The floatation-element aperture 206 may be coaxially aligned with the central longitudinal axis of the compensation nut 200. The base portion 204 may have the floatation-element aperture 206, while the plurality of flexible arms 208 may extend arcuately from the base portion 204 towards one of the plurality of fixing components 210. Each of the plurality of flexible arms 208 may extend as an arc from the base portion 204 towards the one of the plurality of fixing components 210 to form the arc shape. In one example, the plurality of fixing components 210 may be fixedly locked on to one of the components, such as the reinforcement panel 104 of the door panel, as illustrated in FIG. 1B. This allows the base portion 204 and the plurality of flexible arms 208 to float and move about the fixing components 210. In other words, the floatation element 110 may have the plurality of fixing components 210 diametrically opposite to one another about the floatation element 110, extending orthogonally from the base portion 204 parallel to the compensation nut 200. Each of the plurality of fixing components 210 may be inserted and assembled in the door panel, such that the floatation element 110 may float. The floatation element 110 may be movable with respect to each of the plurality of fixing components 210. In an example, each of the plurality of fixing components 210 may be a plurality of columns, where each of the plurality of columns is diametrically opposite to the other of the plurality of columns and each of the plurality of columns may extend orthogonally from a corresponding flexible arms 208 through which it orthogonally extends, where the corresponding flexible arms 208 is one of the plurality of flexible arms 208 that may be corresponding to the each of the plurality of columns.

The mounting element 112 works in conjunction with the floatation element 110 and compensation nut 200. The mounting element 112 has the mounting-element aperture 211, the mounting base 212 and a plurality of floating element 214. The mounting-element aperture 211 may be coaxially aligned with the central longitudinal axis of the hollow cylindrical body of the compensation nut 200 and the floatation-element aperture 206. The mounting element 112 may be interlocked with the floatation element 110. In an example, the mounting element 112 may be interlocked with the floatation element 110 through a snap-fit mechanism between the mounting base 212 and the base portion 204. In other words, the mounting element 112 and the floatation element 110 may be snap-fitted to each other. This in turn causes the mounting base 212 to float corresponding to the base portion 204 and also causes the plurality of floating elements 214 to be moveable. The plurality of floating elements 214 may extend orthogonally from the mounting base 212, parallel to the compensation nut 200. The plurality of floating elements 214 may be, for example, a plurality of guides that may be at least one of claw-shaped, hook-shaped, and grapnel-shaped, and the like. In other words, the mounting element 112 may have a plurality of floating elements 214 diametrically opposite to one another about the mounting element 112 and extending orthogonal from the mounting base 212, where the mounting base 212 may be interlocked with the floatation element 110 via a snap-fit. The plurality of floating elements 214 may be flexible and may be designed as such to have a shape like a claw, grapnel, and the like, as illustrated in FIGS. 2A-2C. As illustrated in FIG. 1B, the plurality of floating elements 214 may also be allowed to move about the corresponding profile only door panel to compensate the varying gap, as will be explained later.

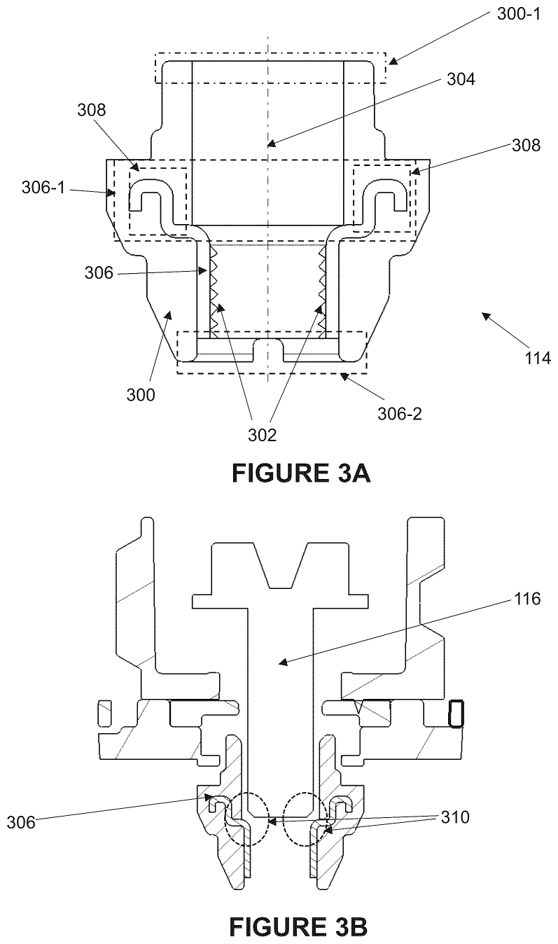

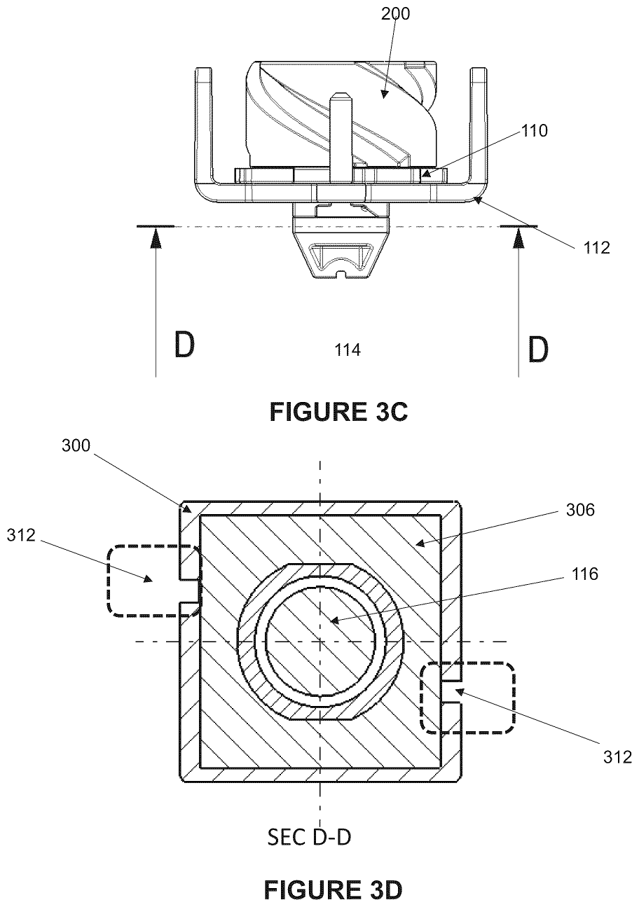

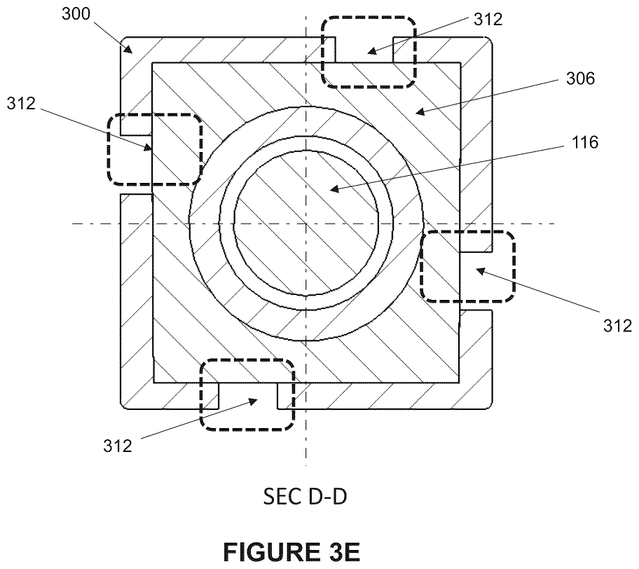

The wing-nut 114 may be the female counterpart to the threaded fastening element 116. The wing-nut 114 of the tolerance compensating fastener 100 may not only aid the tolerance compensating fastener to provide a secure connection point by engaging with the threaded fastening element 116, but also when tightened, the wing-nut 114 may create a strong and stable joint between the two components that are to be fastened, i.e., in this example the reinforcement panel 104 of the door panel and the frame 106 of the door handle assembly 102, but not limited thereto. For the sake of brevity, the components two be fastened may be interchangeably referred to as the door panel and the door handle assembly of the vehicle are the components that need to be fastened. The wing-nut 114 creates an interface with the threaded fastening element 116 to allow precise adjustment of tension and enables both assembly and disassembly of the connection. The wing-nut 114 is designed in a manner to combine strength and adaptability as it is made of a rigid insert (not shown) and a body component (not shown), where the rigid insert is designed in a manner that may provide the necessary strength and durability to accommodate the tension and force applied while the body component is designed in a manner to provide flexibility to easily adjust and move to align the two components, as will be explained later in detail with respect to FIGS. 3A-7. The construction of the wing-nut 114 allows it to withstand higher torque during fastening while receiving the threaded fastening element 116 without failure, while also working in concert with other components like the compensation nut, floatation element, and the mounting element to facilitate multi-directional adjustments. By balancing durability with flexibility, the wing-nut 114 plays a vital role in the tolerance compensating fastener's ability to compensate for manufacturing tolerances and misalignments, ensuring a secure yet adaptable connection between components. The wing-nut 114 will be discussed in detail in FIGS. 3A to 7.

The tolerance compensating fastener 100 may be initially pre-assembled as two separate sub-assemblies. The first sub-assembly, comprising the compensation nut 200, the floatation element 110, and the mounting element 112, may be pre-assembled on the reinforcement panel 104 of the door panel. The wing-nut 114 forms the second sub-assembly with the frame 106. During assembly, the tolerance compensating fastener is pre-assembled/mounted on the reinforcement panel 104 of the door panel while the frame 106 of the door handle assembly 102 is positioned between the wing-nut 114 and the first sub-assembly. The frame 106 accommodating the door handle assembly 102 of the vehicle (not shown) may be positioned to align with the first sub-assembly, further to which the wing-nut 114 may be locked. In this way, the frame 106 may be positioned between the wing-nut 114 and the tolerance compensating fastener 100, such that the respective apertures of the reinforcement panel 104, the through-hole of the tolerance compensating fastener 100, aperture of the frame 106 align along w and may subsequently be fastened through the threaded fastening element 116.

In other words, each of the panels, i.e., the reinforcement panel 104 and the door panel, may have apertures. The tolerance compensating fastener 100 may be pre-assembled and mounted on the reinforcement panel 104 by aligning the first aperture and the through-hole of the tolerance compensating fastener thereby forming a first sub-assembly. After aligning, the frame is positioned to align with the first sub-assembly such that the second aperture may align. Further, the wing-nut 114 is locked with the first sub-assembly with the frame 106 accommodated therebetween. The tolerance compensating fastener 100 is disposed between the door handle assembly 102 and the door panel, where the tolerance compensating fastener 100 has a through-hole aligned with the first aperture and the second aperture. The threaded fastening element 116 may be positioned in the through-hole, the first aperture, and the second aperture, to couple the tolerance compensating fastener 100, the door handle assembly 102, and the door panel. The threaded fastening element 116 may be inserted through the reinforcement panel 104 towards the frame 106 through the tolerance compensating fastener 100.

The threaded fastening element 116 may be inserted by applying torque and passed through the through-hole of the tolerance compensating fastener 100, to fasten the reinforcement panel 104 and the frame 106, and thereby fastening the door handle assembly and the door panel.

While fastening the door handle assembly 102 and the door panel, out of the components of the single-unit of the tolerance compensating fastener mounted on one of the two components (the reinforcement panel 104 in this example), the compensation nut 200 that may be pre-assembled to the reinforcement panel 104, the plurality of fixing components 210 may be locked in and assembled in the reinforcement panel 104. The compensation nut 200 may adjust along its length i.e., by moving either towards the door panel in the direction through which the threaded fastening element 116 is inserted or away from the direction through which the threaded fastening element 116 is inserted into the tolerance compensating fastener 100 to compensate for the varying tolerances. The compensation nut 200 may be able to move and have about 2 degrees of freedom to compensate for the tolerances by moving rotationally and linearly in the same central longitudinal axis as the aperture of the door panel. A movement of the tolerance compensating fastener in at least one direction from the six degrees of freedom is to align the coupled door panel and the door handle assembly. The thread-like profile 201 of the compensation nut 200 may allow varying the distance, but controlling the movement and the distance as per the requirement as the thread-like profile 201 may allow the compensation nut 200 to move to adjust only based on the requirement and not just slide. In other words, as the compensation nut 200 may be rotated to move along its axis to have about 2 degrees of freedom, allowing for precise adjustment of the gap between the two components i.e., the frame 106 and the reinforcement panel 104. This movement by the compensation nut 200 provides the initial compensation for tolerances in the direction of the central longitudinal axis that runs through the center of the tolerance compensating fastener 100, aligning with the direction in which the threaded fastening element 116 is inserted and tightened. This imaginary line of the central longitudinal axis passes through the center of the compensation nut 200, the floatation element 110, the mounting element 112, and the wing-nut 114. The thread-like profile 201 ensures a secure and stable connection between the tolerance compensating fastener 100 through the compensation nut 200 and the one of the two components i.e., in this case, the reinforcement panel 104 of the door panel, while still permitting controlled adjustments as needed during the fastening process.

Correspondingly, the floatation element 110, due to its floating nature may adjust and move the base portion 204 and the plurality of flexible arms 208 to move to have about 4 degrees of freedom about the plurality of fixing component 210. As the floatation element 110 is interlocked with the mounting element 112, the mounting element 112 may because of the plurality of flexible arms 208 may also cause the plurality of floating elements 214 to adjust and float to have 4 degrees of freedom and move vertically and laterally to align the two components and correspondingly compensate the misalignment. The plurality of floating elements 214 may move from four degrees of freedom to correct the misalignment between the two components.

In this manner, the compensation nut 200 may have two degrees of freedom and the floatation element along with the mounting element 112 provide four degrees of freedom, and this way, the tolerance compensating fastener 100 of the present subject matter through each component attains 6 (six) degrees of freedom.

In view of the above, the tolerance compensating fastener 100 may compensate for varying tolerances in different directions.

FIG. 3A illustrates a sectional view of the wing-nut 114 in a tolerance compensating fastener 100, according to an example of the present subject matter. FIG. 3B illustrates a sectional view of the tolerance compensating fastener 100 with a threaded fastening element 116, according to an example of the present subject matter FIG. 3C illustrates an isometric view of the tolerance compensating fastener 100, according to an example of the present subject matter. FIG. 3D illustrates a sectional bottom view of the tolerance compensating fastener 100 across sectional plane D-D shown in FIG. 3C, in accordance with an example of the present subject matter. FIG. 3E illustrates a sectional bottom view of the tolerance compensating fastener across sectional plane D-D shown in FIG. 3C, in accordance with another example of the present subject matter. For the sake of brevity, FIGS. 3A-3F have been explained in conjunction with each other.

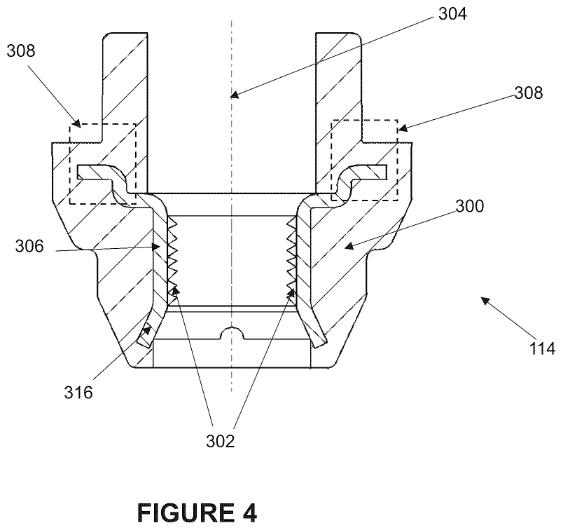

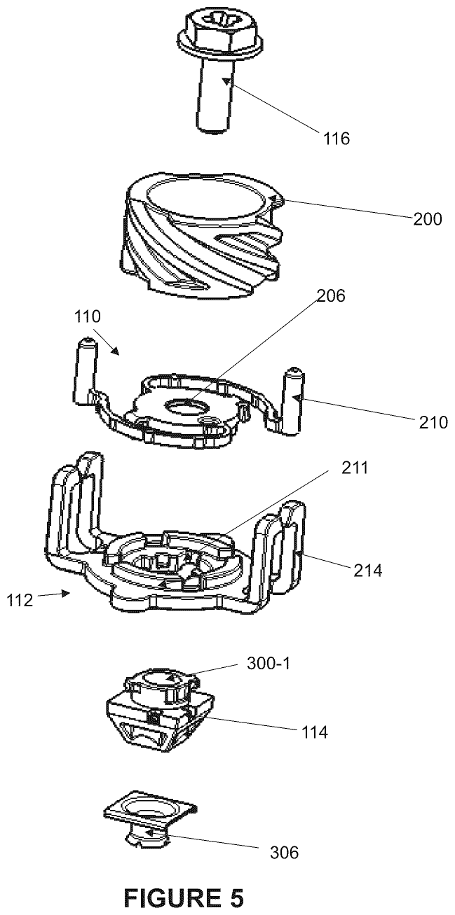

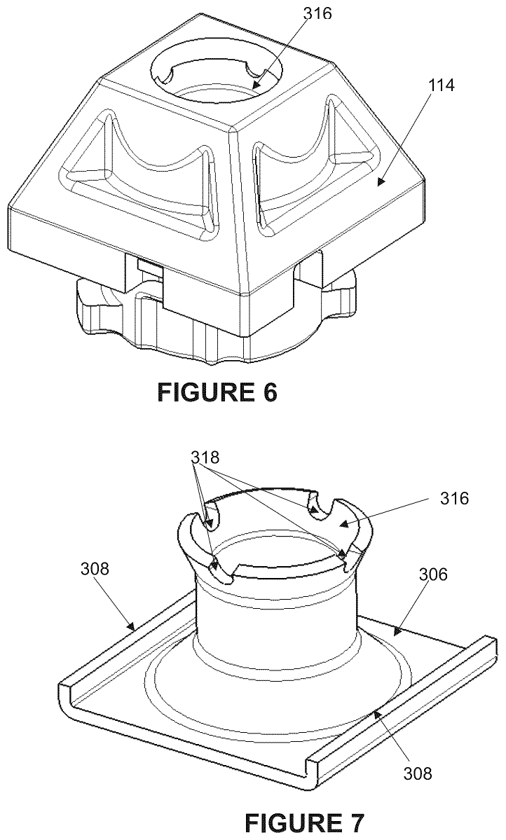

Further, FIG. 4 illustrates a sectional view of the wing-nut 114 in a tolerance compensating fastener 100 having a flared portion 316 in a rigid insert 306, according to another example of the present subject matter. FIG. 5 illustrates an exploded view of the tolerance compensating fastener 100 including the rigid insert 306, according to an example of the present subject matter. FIG. 6 illustrates a perspective view of the wing-nut 114 showing the rigid insert 306 therein, according to another example of the present subject matter. FIG. 7 illustrates a perspective view of the rigid insert 306 of the wing-nut 114, according to the example of the present subject matter shown in FIG. 6. For the sake of brevity, FIGS. 4-7 have been explained in conjunction and along with FIGS. 3A-3D.

In the present subject matter, the wing-nut 114 of the tolerance compensating fastener 100 may receive the threaded fastening element 116 while fastening the two components that may be for instance, but not limited thereto, the frame 106 and the reinforcement panel 104, as also illustrated above.

The wing-nut 114 may have the rigid insert 306 and the body component 300. The rigid insert 306 may be formed as a hollow cylindrical body having a proximal end 306-1 and a distal end 306-2, where the proximal end 306-1 may be an end of the rigid insert 306 facing towards an end of the wing-nut 114 for receiving the threaded fastening element 116 and the distal end 306-2 be axially opposite to the proximal end 306-1, as also illustrated in FIG. 3A. The rigid insert 306 may include a plurality of threads 302 and a plurality of retention elements 308. The plurality of threads 302 may be formed on an inner wall of the hollow cylindrical body. The plurality of retention elements 308 may be at the proximal end 306-1 of the rigid insert 306. Each of the plurality of retention elements 308 may aid in integrating the rigid insert 306 in the body component 300. In an example, each of the plurality of retention elements 308 may have an arduous profile at the proximal end 306-1 of the rigid insert 306, where each of the plurality of retention elements 308 is diametrically opposite to one another and has a free retention end facing the distal end 306-2 of the rigid insert 306. The arduous profile of each of the plurality of the retention element 308 may be configured to maintain integration between the rigid insert 306 and the body component 300 even when subjected to opposing forces, thereby enhancing the overall durability and performance of the wing-nut 114.

The body component 300 may be overmolded over the rigid insert 306, such that body component 300 may encapsulate the rigid insert 306. In an example, the body component 300 may have an opening 300-1, coaxial with a central longitudinal axis 304 of the rigid insert 306, to create a through-hole with the hollow cylindrical body of the rigid insert 306 to receive the threaded fastening element 116. The opening 300-1 may be also be the opening of the wing-nut 114.

In an example, the body component 300 may be made of plastic material and the rigid insert 306 may be made of metal.

In an example, the plurality of threads 302 on the wing-nut 114 in the present subject matter may be consistent throughout, such that each of the plurality of threads 302 may have the same dimensions and may be equidistant from one another to efficiently accommodate the threaded fastening element 116. In one example, the plurality of threads 302 may be formed of any one of ACME threads, square-shaped threads, and metric threads. The wing-nut 114 may have the central longitudinal axis 304, such that the plurality of threads 302 may be on the distal end 306-2 of the central longitudinal axis 304 of the wing-nut 114.

In an example, the wing-nut 114 may include the rigid insert 306, as illustrated in FIGS. 3A-3E and may be fabricated with the body component 300 by the process of overmolding. The rigid insert 306, through overmolding, may provide the required durability and strength through rigid insert 306 and the flexibility to adjust with respect to the tolerances through the plastic fabrications of the wing-nut 114. The rigid insert 306 may include machined metal components secured into the wing-nut 114, i.e., overmolded with body component 300. The rigid insert 306 of the wing-nut 114 may be designed as such to have the plurality of threads 302 in the inner circumference.

In one example, the rigid insert 306 may have a flared portion 316 extending from the threaded portion at the distal end of the rigid insert 306, as illustrated in FIGS. 4-7. In an example, the rigid insert 306 may have the flared portion 316 at the distal end 306-2 of the rigid insert 306 extending from the plurality of threads 302, where the flared portion 316 may extend radially outwards and away from the central longitudinal axis 304. In an example, the flared portion 316 may be designed as such to have conical shape extending outwards and away from the central longitudinal axis 304 at the distal end of the rigid insert 306, as illustrated in FIG. 7. In other words, the flared portion 316 may have a greater diameter than the rest of the rigid insert 306. The expanded shape of the flared portion 316 may prove to be effective during the process of overmolding of body component 300 over the rigid insert 306 i.e., by preventing the body component 300 to overflow beyond the edge of the flared portion 316. In the absence of the flared portion 316, the body component 300 may flow beyond the edge of the rigid insert 306 and may enter inner wall of the rigid insert 306 and towards the plurality of threads 302, and may accumulate over the plurality of threads 302, thereby adversely affecting the performance of the wing-nut 114 during assembly.

Additionally, the flared portion 316 on the rigid insert 306 is provided with a plurality of notches 318 to accommodate the flaring of the rigid insert 306 at that edge without the material of the rigid insert 306 cracking or being damaged when the edge of the rigid insert 306 is expanded. The plurality of notches 318 may be positioned circumferentially about an edge of the rigid insert 306 at the distal end 306-2 and equidistant with respect to each other. In other words, the provision of the notches 318 avoids damage to the rigid insert 306 in the proximity of the edge where the flared portion 316 is formed, during the flaring operation at that edge of the flared portion 316 extending away from the plurality of threads 302. In an example, each of the plurality of notches 318 may be equidistant from one another on the edge of the flared portion 316 of the rigid insert 306. However, other designs of provision and arrangement of the slits around the edge for the purpose of preventing damage to the edge are also envisaged as part of the present subject matter.

As stated above, the rigid insert 306 may include the plurality of retention elements 308 at the proximal end of the rigid insert 306, which may have the arduous profile at the proximal end 306-1 of the rigid insert 306. Each of the plurality of retention elements 308 may be diametrically opposite to one another and have the free retention end, i.e., the end of the profile of the each of the plurality of the retention elements 308 may be designed in a manner to face towards the distal end 306-2 of the rigid insert 306. The arduous profile of the each of the plurality of the retention element 308 may be designed in a manner to maintain integration between the rigid insert 306 and the body component 300 even when subjected to opposing forces. In an example, the arduous profile each of the plurality of the retention elements 308 may be designed to be corrugated-shaped, curved-shaped, hooked-shaped, arch-shaped, and the like, with the free retention end always facing towards the distal end 306-2. In one example, each of the retention elements 308 may be designed in a manner to extend from a second axial direction towards a first axial direction and further, extend radially from the central longitudinal axis 304. In this example, each of the plurality of retention elements 308 may extend in radially opposite directions with respect to each other. The plurality of retention elements 308 after extending radially from the central longitudinal axis 304 may extend axially from a first axial direction to a second axial direction. In this example, the first axial direction may be the direction closer to the proximal end and the second axial direction may be closer to the distal end. The plurality of retention elements 308 of the wing-nut 114 may be designed as such that the rigid insert 306 is completely locked in with the plastic fabrications of the wing-nut 114 via the plurality of retention elements 308. In another example, the wing-nut 114 may include at least one wing extending along the central longitudinal axis 304 of the wing-nut 114. The arduous profile may be a complex, non-linear shape of each of the plurality of the retention element 308 to enhance the integration and locking of the rigid insert 306 within the body component 300 of the wing-nut 114. Located at the proximal end 306-1 of the rigid insert 306, these retention elements 308 feature an intricate geometry that may include curved, hooked, arch-shaped, corrugated, or undulating surfaces, not limited thereto. This complex profile increases the surface area and creates mechanical interlocking between the rigid insert 306 and the body component 300. Each of the plurality of the retention elements 308 have a free retention end facing the distal end 306-2 of the rigid insert 306, allowing them to resist forces that would pull the insert out of the body component 300. This design ensures that the rigid insert 306 remains securely interlocked and fixed within the body component 300, even when subjected to high torque or opposing forces during fastening. The arduous profile thus prevents the rigid insert 306 from shearing or cutting through the body component 300.

In an example, each of the plurality of retention elements 308 of the rigid insert 306 may be connected to the respective side of the plurality of threads 302 to form a screw guide 310, as shown in FIG. 3B. In an example, the screw guide 310 may also be provided in implementations where the rigid insert 306 may have the flared portion 316.

As each of the plurality of retention elements 308 extends in radially opposite directions, each of the plurality of retention elements 308 may be connected with a side of the plurality of threads 302 that is closer to form the screw guide 310 at each side of the plurality of threads 302. The screw guide 310 may be a part of the rigid insert 306. The distance between each screw guide 310 of at least two screw guides at each side of the plurality of threads 302 on the inner walls of the rigid insert 306 may be less than the distance between the plurality of threads 302 on each side of the inner wall. The screw guide 310 may guide the threaded fastening element 116 on which the torque is applied while being inserted into the tolerance compensating fastener 100 towards the plurality of threads 302 for fastening. The compositions of the screw guide 310 may be of a metal, therefore, the screw guide 310 may be able to withstand more torque and may be designed such that the screw guide 310 may easily be able to guide and lead the way for the screw towards the plurality of threads 302 to fasten efficiently.

For efficiently locking the rigid insert 306 to be surrounded by the body component 300 in the wing-nut 114, a mold (not shown) may be designed that may have at least two holders (not shown) to hold the rigid insert 306 while the body component 300 may be overmolded over it, as illustrated in FIG. 3D. In this way, the holders may cause a corresponding impression 312 being formed on the body component 300. Each of the two holders in an example provided on at least two opposite sides of the mold, such that each of the two holders are diagonally opposite with respect to each other. During the process of overmolding, the mold may hold the rigid insert 306 through each of the two holders, thereby ensuring to prevent any movement either rotational movement or lateral movement of the rigid insert 306 at the time of overmolding of the body component 300, to form the wing-nut 114. In another example, the mold may be designed to have at least four holders. Each of the four holders may be provided on one of the four sides of the mold, such that each of the four holders is diagonally opposite with respect to each other. In this way, the holders may cause a corresponding impression 312 being formed on the body component 300, as illustrated in FIG. 3E. During the process of overmolding, the mold may hold the rigid insert 306 through each of the two holders, thereby ensuring to prevent any movement either rotational movement or lateral movement of the rigid insert 306 at the time of overmolding of the plastic, to form the wing-nut 114. This, in turn, allows the rigid insert 306 to effectively mold in and lock with plastic fabrications of the wing-nut 114.

Through the above-mentioned examples, the rigid insert 306 may be completely locked in the wing-nut 114 along with the body component 300 fabrications during the overmolding process. Additionally, the rigid insert 306 through the above-mentioned wings may ensure that the rigid insert 306 is completely locked in with the body component 300 of the wing-nut 114 and does not shear or cut off the wing-nut 114 as and when more torque is applied by the threaded fastening element 116 while fastening. In this manner, the wing-nut 114 may withstand more torque. Through these implementations, each of the plurality of the retention elements 308 of the wing-nut 114 may provide a positive lock with plastic fabricated parts of the wing-nut 114 while the process of overmolding the rigid insert 306 part may cling and lock tenaciously with the wing-nut 114, i.e., the body component 300 integrates and mates with the rigid insert 306. Through the above-mentioned implementations, the rigid insert 306 is efficiently locked in and does not shear and cut the wing-nut 114 as and when the screw with higher torque is inserted.

In view of the above arrangement, the tolerance compensating fastener 100 may have the flexibility to compensate for the tolerance variations at different and multiple directions through plastic fabrications as well as provide strength to withstand more torque without breaking through the rigid insert 306. The tolerance compensating fastener 100 of the present subject matter may be designed as such to be durable, effective, and less costly.

In view of the above arrangement, the tolerance compensating fastener 100 may be designed as such to be durable, effective, and less costly. The tolerance compensating fastener 100 through the rigid insert 306 in the wing-nut 114 provides flexibility to an operator to fasten components at varying torque as the tolerance-adjusting component may be able to withstand the torque without breaking. Additionally, the plurality of threads 302 provided on the wing-nut 114 in the tolerance compensating fastener 100 may be consistent and may not easily break off, as the rigid insert 306 may also provide support to the plurality of threads 302. Additionally, the tolerance compensating fastener 100 is fabricated with the body component 300 with rigid insert 306 via overmolding, which is less time-consuming and less expensive. Additionally, provides the strength of the rigid insert 306 along with the flexibility to the tolerance compensating fastener 100 to compensate for varying tolerances at different directions.

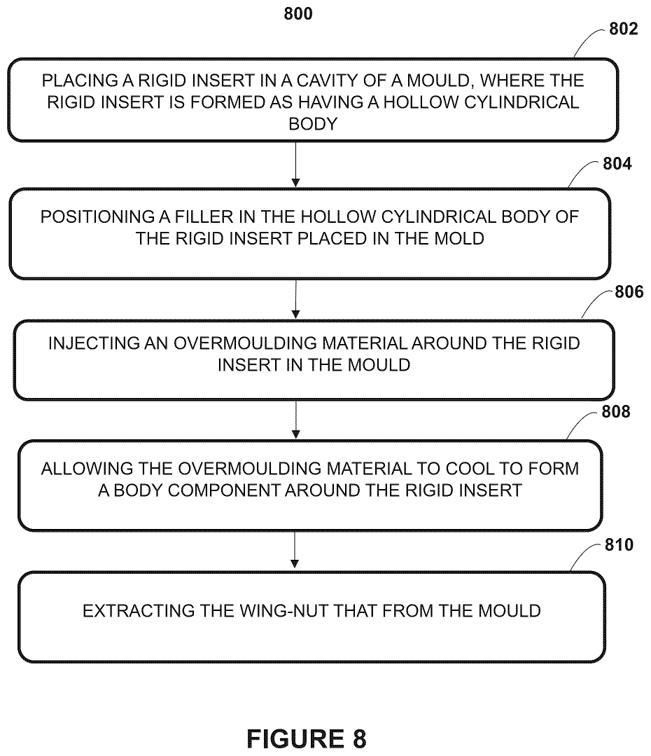

FIG. 8 provides an illustration of a method 800 of manufacturing the wing-nut in accordance with examples of the present subject matter. The order in which the method is described is not intended to be construed as a limitation, and any number of the described method blocks may be combined in any order to implement the methods, or an alternative method.

It may also be understood that the wing-nut manufactured may be the wing-nut 114 as explained above in reference to FIGS. 1A-7. Correspondingly the rigid insert may correspond to the rigid insert 306 illustrated with respect to FIGS. 3A-7 and the body component may correspond to the body component 300 illustrated with respect to FIGS. 3A-7.

At block 802, a rigid insert may be placed in a cavity of a mold, where the rigid insert may be formed as having a hollow cylindrical body having a proximal end and a distal end axially opposite to the proximal end. The rigid insert may include a plurality of threads formed on an inner wall of the hollow cylindrical body, and a plurality of retention elements at the proximal end. The plurality of threads may correspond to the plurality of threads and the plurality of retention elements may correspond to the plurality of retention elements 308, as have been discussed above. Further, the mold as also illustrated above may be any mold, that may have a cavity corresponding to the size of the threaded fastening element 116.

At block 804, a filler may be positioned in the hollow cylindrical body of the rigid insert placed in the mold. The filler may only be a filling component, to block any entry into the rigid insert through the proximal end. This way the overmolded material does not pass through the proximal end of the rigid insert into the inner walls of the rigid insert and damages the screw guide or the plurality of threads.

At block 806, an overmolding material may be injected around the rigid insert in the mold. The overmolding material may surrounds the rigid insert and may form an opening coaxial with the hollow cylindrical body of the rigid insert, to create a through-hole with the hollow cylindrical body of the rigid insert. The opening may correspond to the opening 300-1 and the central longitudinal axis may correspond to the central longitudinal axis 304, as have been discussed above. The overmolding material is made of plastic and the rigid insert is made of metal.

At block 808, the overmolding material may be allowed to cool to form a body component around the rigid insert, where the plurality of retention elements is to interlock and fix to the body component. The body component poured in the mold surrounding the rigid insert may be allowed to be cooled down to effectively encapsulate the rigid insert and form the wing-nut.

At block 810, the wing-nut may be extracted from the mold. This may be done after the wing-nut has been manufactured.

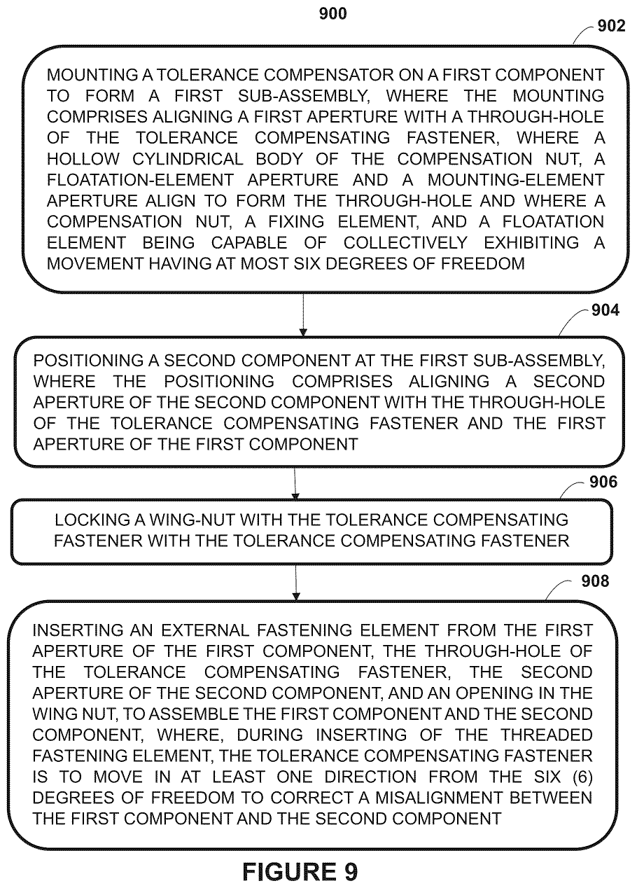

FIG. 9 provides an illustration of a method 900 for assembling a first component and a second component in accordance with examples of the present subject matter. The order in which the method is described is not intended to be construed as a limitation, and any number of the described method blocks may be combined in any order to implement the methods, or an alternative method.

In one example, the first component and the second component may be any components that may require to be fastened with each other. In an example, and in view of the illustration showcased in above figures, the first component and the second component may be a door panel and door handle assembly 102. The first component and the second component as stated above may be any components and the implementations are not limited thereto. The tolerance compensating fastener may the tolerance compensating fastener 100 as illustrated above with respect to FIGS. 1A-7.

At block 902, a tolerance compensating fastener 100 may be mounted on the first component (that may be the door panel in view of the examples illustrated hereinabove) (not shown) to form a first sub-assembly. The tolerance compensating fastener may have a through-hole and the first component may have a first aperture and wherein the mounting comprises aligning the first aperture with the through-hole. The first sub-assembly may be formed by pre-assembling the components of the tolerance compensating fastener i.e., the compensation nut, the floatation element, the mounting element as a single-unit on the first component. In an example, the compensation nut may be a hollow cylindrical body and may have an external wall having a thread-like profile. The compensation nut may have the insertion end, and the free end may be distal to the insertion end. The floatation element may engage at the free end of the compensation nut. The floatation element may have a floatation-element aperture coaxially aligned with respect to a central longitudinal axis of the hollow cylindrical body of the compensation nut. The mounting element may have a mounting-element aperture coaxially aligned with the central longitudinal axis of the compensation nut and the floatation-element aperture of the floatation element. The mounting element may be interlocked with the floatation element. The hollow cylindrical body of the compensation nut, the floatation-element aperture and the mounting-element aperture align to form the through-hole where the base portion of the floatation element may be locked in with the mounting base by snap fit. As a result, any movement of the floatation element may cause the mounting element to float and move. The mounting also includes aligning the first aperture with a through-hole of the tolerance compensating fastener, where the compensation nut, the floatation element, and the mounting element are capable of collectively exhibiting a movement having at most six degrees of freedom. The hollow cylindrical body of the compensation nut, the floatation-element aperture and the mounting-element aperture align to form the through-hole The through-hole of the tolerance compensating fastener may be a continuous opening or passage that extends completely through the body of the tolerance compensating fastener from one end to the other. The through-hole may be an opening that may run along the central longitudinal axis of the tolerance compensating fastener and allows for the insertion and receiving of another fastening element or the passage of materials, such as the threaded fastening element. It may also be understood that the tolerance compensating fastener and its components illustrated herein may correspond to the tolerance compensating fastener 100 and its components as explained above in reference to FIGS. 1A-7. It may also be understood that the threaded fastening element corresponds to the threaded fastening element 116 illustrated herein as explained above in reference to FIGS. 1A-7

At block 904, the second component may be positioned with the first sub-assembly, where the positioning includes may align a second aperture of the second component with the through-hole of the tolerance compensating fastener and the first aperture of the first component.

At block 906, the wing-nut of the tolerance compensating fastener may be locked with the tolerance compensating fastener. The wing-nut may include a rigid insert and the body component. The rigid insert formed as a hollow cylindrical body having a proximal end and a distal end, the proximal end being an end of the rigid insert facing towards an end of the wing-nut for receiving the threaded fastening element and the distal end being axially opposite to the proximal end. The rigid insert may include a plurality of threads and the plurality of retention elements. The plurality of threads may be formed on an inner wall of the hollow cylindrical body. Further, the plurality of retention elements may be at the proximal end of the rigid insert. Further, the body component may be surrounding the rigid insert and may have an opening, coaxial with a central longitudinal axis of the rigid insert, to create a through-hole with the hollow cylindrical body of the rigid insert to receive the threaded fastening element. Further, each of the plurality of retention elements may be encapsulated by the body component to be interlocked and fixed in the body component 300. At block 906, locking includes locking comprises sandwiching the second component between the wing-nut and the first sub-assembly. Locking the wing-nut with the first sub-assembly may be to position the second component in between the wing-nut and the first sub-assembly, where the wing-nut and the second component may form a second sub-assembly.

At block 908, the threaded fastening element may be inserted from the first aperture of the first component, through the through-hole of the tolerance compensating fastener, the second aperture of the second component, and into an opening in the wingnut, to assemble the first component and the second component. By inserting of the threaded fastening element, the tolerance compensating fastener may move in at least one direction from the six (6) degrees of freedom to correct misalignment and gap and any variations between the first component and the second component. The tolerance compensating fastener is designed to correct misalignments between two components in up to six degrees of freedom, encompassing both positional and rotational adjustments. This means the tolerance compensating fastener can compensate for gaps (linear displacements) as well as angular misalignments between the components. The six degrees of freedom may include, for example, three translational movements (up/down, left/right, forward/backward) and three rotational movements (pitch, yaw and roll). As the threaded fastening element is inserted, the tolerance compensating fastener having the compensation nut, floatation element, and mounting element—can collectively move in any combination of these six degrees. This movement allows the tolerance compensating fastener to dynamically adjust its position and orientation, effectively filling gaps and correcting misalignments between the two components being fastened. In case the issue is a linear offset causing a gap, or an angular misalignment causing the components to be tilted relative to each other, the tolerance compensating fastener may have the ability to move in these six degrees of freedom enabling it to adapt and ensure proper alignment, contact, and gap between the components. This comprehensive adjustment capability ensures that the fastener can accommodate a wide range of manufacturing tolerances and assembly variations, resulting in a secure and properly aligned connection.

Although examples for the wing-nut 114 of the tolerance compensating fastener 100 have been described in language specific to structural features and/or methods, it is to be understood that the appended claims are not limited to the specific features described. Rather, the specific features are disclosed as examples of the tolerance compensating fastener 100.

What is claimed is:

1. A wing-nut (114) cooperable with a threaded fastening element (116), the wing-nut (114) comprising:
a rigid insert (306) formed as having a hollow cylindrical body having a proximal end (306-1) and a distal end (306-2), the proximal end (306-1) being an end of the rigid insert (306) towards an end of the wing-nut (114) to receive the threaded fastening element (116) and the distal end (306-2) being axially opposite to the proximal end (306-1), the rigid insert (306) comprising:
a plurality of threads (302) formed on an inner wall of the hollow cylindrical body, and
a plurality of retention elements (308) at the proximal end (306-1) of the rigid insert (306); and
a body component (300) surrounding the rigid insert (306), the body component (300) having an opening, coaxial with a central longitudinal axis of the rigid insert (306), to create a through-hole with the hollow cylindrical body of the rigid insert (306) to receive the threaded fastening element (116),
wherein each of the plurality of retention elements (308) is encapsulated by the body component (300) to be interlocked and fixed in the body component (300).

2. The wing-nut (114) of claim 1, wherein the body component (300) is made of plastic material and the rigid insert (306) is made of metal.

3. The wing-nut (114) of claim 1, wherein the plurality of threads (302) is formed of any one of ACME threads, square-shaped threads, and metric threads.

4. The wing-nut (114) of claim 1, wherein the rigid insert (306) has a flared portion (316) at the distal end (306-2) of the rigid insert (306) extending from the plurality of threads (302), wherein the flared portion (316) extends radially outwards and away from the central longitudinal axis.

5. The wing-nut (114) of claim 4, wherein the flared portion (316) comprises a plurality of notches (318) positioned circumferentially about an edge of the rigid insert (306) at the distal end (306-2) and equidistant with respect to each other.

6. The wing-nut (114) of claim 1, wherein each of the plurality of retention elements (308) have an arduous profile at the proximal end (306-1) of the rigid insert (306), wherein each of the plurality of retention elements (308) is diametrically opposite to one another and have a free retention end facing the distal end (306-2) of the rigid insert (306), wherein the arduous profile of each of the plurality of the retention elements (308) is configured to maintain integration between the rigid insert (306) and the body component (300) even when subjected to opposing forces.

7. A tolerance compensating fastener (100) to align two components to be fastened thereby using a threaded fastening element (116), the tolerance compensating fastener (100) comprising:
a compensation nut (200) having a hollow cylindrical body, an external wall thereof having a thread-like profile (201), the compensation nut (200) having a free end (202-2) and an insertion end (202-1), wherein the insertion end (202-1) is to receive the threaded fastening element (116) and the free end (202-2) is distal to the insertion end (202-1);
a floatation element (110) engaged at the free end (202-2) of the compensation nut (200), the floatation element (110) comprising a floatation-element aperture (206) coaxially aligned with respect to the hollow cylindrical body of the compensation nut (200), the floatation element (110) being mountable to one of the two components;
a mounting element (112) having a mounting-element aperture (211) coaxially aligned with a central longitudinal axis of the compensation nut (200) and the floatation-element aperture (206) of the floatation element (110), wherein the mounting element (112) is interlocked with the floatation element (110) and is movably mountable to the one of the two components,
wherein the compensation nut (200), the floatation element (110), and the mounting element (112) are capable of collectively exhibiting a movement having at most six degrees of freedom; and
a wing-nut (114) mountable, away from the insertion end (202-1), to one of the compensation nut (200), the floatation element (110), and the mounting element (112), and to receive the threaded fastening element (116), the wing-nut (114) comprising:
a rigid insert (306) formed as having a hollow cylindrical body having a proximal end (306-1) and a distal end (306-2), the proximal end (306-1) being an end of the rigid insert (306) towards an end of the wing-nut (114) to receive the threaded fastening element (116) and the distal end (306-2) being axially opposite to the proximal end (306-1), the rigid insert (306) comprising:
a plurality of threads (302) formed on an inner wall of the hollow cylindrical body; and
a plurality of retention elements (308) at the proximal end (306-1) of the rigid insert (306); and
a body component (300) surrounding the rigid insert (306), the body component (300) having an opening, coaxial with a central longitudinal axis of the rigid insert (306), to create a through-hole with the hollow cylindrical body of the rigid insert (306) to receive the threaded fastening element (116);
wherein each of the plurality of retention elements (308) is encapsulated by the body component (300) to be interlocked and fixed in the body component (300).

8. The tolerance compensating fastener (100) of claim 7, wherein the mounting element (112) and the floatation element (110) are snap-fitted to each other.

9. The tolerance compensating fastener (100) of claim 7, wherein the floatation element (110) comprises a plurality of flexible arms (208), a plurality of fixing components (210), and a base portion (204), wherein the base portion (204) comprises the floatation-element aperture (206), and wherein each of the plurality of flexible arms (208) extends arcuately from the base portion (204) towards each of the plurality of fixing components (210), and wherein each of the plurality of fixing components (210) is configured to be fixedly locked on the one of the two components and each of the plurality of flexible arms (208) is configured to float about each of the plurality of the fixing components (210).

10. The tolerance compensating fastener (100) of claim 9, wherein the plurality of fixing components (210) comprises a plurality of columns, wherein each of the plurality of columns is diametrically opposite to the other of the plurality of columns, and each of the plurality of columns extend orthogonally from a corresponding flexible arms (208).

11. The tolerance compensating fastener (100) of claim 7, wherein the mounting element (112) comprises a mounting base (212) and a plurality of floating elements (214), wherein the mounting-element aperture (211) is on the mounting base (212) and wherein each of the plurality of floating elements (214) is diametrically opposite to one another about the mounting element (112) and extend orthogonally from the mounting base parallel to the compensation nut (200).

12. The tolerance compensating fastener (100) of claim 7, wherein each of the plurality of floating elements (214) are at least one of claw-shaped, hook-shaped, and grapnel-shaped.

13. The tolerance compensating fastener (100) of claim 7, wherein the body component (300) is made of plastic material and the rigid insert (306) is made of metal.

14. The tolerance compensating fastener (100) of claim 7, wherein the plurality of threads (302) of the wing-nut (114) is formed of any one of ACME threads, square-shaped threads, and metric threads.

15. The tolerance compensating fastener (100) of claim 7, wherein the rigid insert (306) has a flared portion (316) at the distal end (306-2) of the rigid insert (306) extending from the plurality of threads (302), wherein the flared portion (316) extends radially outwards and away from the central longitudinal axis.

16. The tolerance compensating fastener (100) of claim 15, wherein the flared portion (316) comprises a plurality of notches (318) positioned circumferentially about an edge of the rigid insert (306) at the distal end (306-2) and equidistant with respect to each other.

17. The tolerance compensating fastener (100) of claim 15, wherein each of the plurality of retention elements (308) have an arduous profile at the proximal end (306-1) of the rigid insert (306), wherein each of the plurality of retention elements (308) is diametrically opposite to one another and have a free retention end facing the distal end (306-2) of the rigid insert (306), wherein the arduous profile of the retention element is configured to maintain integration between the rigid insert (306) and the body component (300) even when subjected to opposing forces.

18. A door assembly for a vehicle, wherein the door assembly comprises:
a door handle assembly (102) having a frame (106) and a first aperture;
a door panel having a reinforcement panel (104) and a second aperture aligned with the first aperture;
a tolerance compensating fastener (100) of claim 7 disposed between the door handle assembly (102) and the door panel, the tolerance compensating fastener (100) comprising a through-hole aligned with the first aperture and the second aperture; and
a threaded fastening element positioned in the through-hole, the first aperture, and the second aperture, to couple the tolerance compensating fastener (100), the door handle assembly (102), and the door panel, wherein a movement of the tolerance compensating fastener in at least one direction from six degrees of freedom is to align the door panel and the door handle assembly (102).

19. A method (800) for manufacturing a wing-nut (114), wherein the method comprises:
placing a rigid insert (306) in a cavity of a mold, wherein the rigid insert (306) is formed as having a hollow cylindrical body having a proximal end (306-1) and a distal end (306-2) axially opposite to the proximal end (306-1), the rigid insert (306) comprising:
a plurality of threads (302) formed on an inner wall of the hollow cylindrical body; and
a plurality of retention elements (308) at the proximal end (306-1);
positioning a filler in the hollow cylindrical body of the rigid insert (306) placed in the mold;
injecting an overmolding material around the rigid insert (306) in the mold, wherein overmolding material surrounds the rigid insert (306) and forms an opening coaxial with the hollow cylindrical body of the rigid insert (306), to create a through-hole with the hollow cylindrical body of the rigid insert (306);
allowing the overmolding material to cool to form a body component (300) around the rigid insert (306), wherein the plurality of retention elements (308) are to interlock and fix to the body component (300); and
extracting the wing-nut (114) from the mold.

20. The method (800) of claim 19, wherein the placing the rigid insert (306) comprises holding the rigid insert (306) using a plurality of holders of the mold before injecting the overmolding material.
